(19) United States
(12) Patent Application Publication
(10) Pub. No.: US 2023/0294350 A1
(43) Pub. Date: Sep. 21, 2023

(54) SELF-ALIGNING MASTER AREA MULTIPLICATION FOR CONTINUOUS EMBOSSING

(71) Applicants: Alexander D. Laws, Portland, OR (US); Khampeng Thammasouk, Corvallis, OR (US); James E. Abbott, Albany, OR (US)

(72) Inventors: Alexander D. Laws, Portland, OR (US); Khampeng Thammasouk, Corvallis, OR (US); James E. Abbott, Albany, OR (US)

(21) Appl. No.: 18/123,190

(22) Filed: Mar. 17, 2023

Related U.S. Application Data
(60) Provisional application No. 63/321,629, filed on Mar. 18, 2022.

(51) Int. Cl. B29C 59/02; B29C 59/04

(52) U.S. Cl. CPC B29C 59/022; B29C 59/04

(57) ABSTRACT

The present invention pertains to the embossing of a pattern using resin formulations to create a stamp to continue the embossing pattern. Since the pattern is repeated, you can peel the stamp from the embossing over an integer of number patterns and put it back in the embossing in a different location. This realization enables a novel approach to seamlessly replicating a pattern either on a flat area or in a seamless continuous cylinder. The stitching and mastering manufacturing processes and techniques of the present invention present a solution to an industry challenge. The stitching allows for the verticalization of all important manufacturing steps, eliminating the need to rely on a third party for mastering.

### CROSS REFERENCE TO RELATED APPLICATIONS

This application claims the benefit of U.S. Provisional Application Ser. No. 63/321,629, filed Mar. 18, 2022, the contents of which are incorporated herein by reference.

### BACKGROUND OF THE INVENTION

The present invention relates to a system and method for stitching and mastering manufacturing of embossed structures.

When using a micro-scale three-dimensional optical feature to create devices such as retroreflectors, holograms, or micro-Frensel lenses, the techniques are not able to be used to expand wide areas. These techniques create a space between films, which is not desirable for making something like a window. This leads for the need for technology that can create micron sized features over wide variety of ranges. There already exists techniques that make the distance between seams smaller, but the distance still exists. One of these techniques butts small masters together, then electroform copies of the enlarged version and then butt those together. This eventually creates a cylinder and the fins created by the seams are ground off. Another solution uses a step and repeat process with imprinting, lithography, micro-machining is performed on an area and then the process is moved over and repeated. Depending on the accuracy of the movement, there still is a chance of creating defects and distance between the seams. There exists a need to create a technique that can create embossed patterns over large distances that create no seams between patterns.

### SUMMARY OF THE INVENTION

The present invention pertains to the embossing of a pattern using resin formulations to create a stamp to continue the embossing pattern. Since the pattern is repeated, you can peel the stamp from the embossing over an integer of number patterns and put it back in the embossing in a different location. This realization enables a novel approach to seamlessly replicating a pattern either on a flat area or in a seamless continuous cylinder.

The self-aligning process of embossing patterns on a flat surface are as follows. It starts with the imprinting or embossing of a pattern using a stamp and liquid resin on a flat substrate. The resin is spread on the substrate. The plastic film is then stamped into resin to create the formed pattern. The stamped resin is then cured by way of ultraviolet curing, which is a photochemical process in which high-intensity ultraviolet light is used to instantly cure or dry inks, coatings or adhesives. Ultraviolet formulations are liquid monomers and oligomers mixed with a small percent of photo-initiators, and then exposed to ultraviolet energy. The stamp is then peeled out of the embossing, reserving the stamp. The edge of the embossing is then cleaned off so that any edge defects or excess resin is removed and only the pattern remains. The substrate is then ready for alignment. The stamp is then shifted over so about ¼″ of the pattern is overlapped with the embossed pattern. Once the stamp is well aligned, the stamp will be pressed into the embossing of a small area. The engagement will cause self-alignment of the pattern on the nano-scale and the engaged area can be expanded from the initial spot to eventually cover the entire overlapped area. Next clamp the engaged area of the pattern in a lamination roller to keep the pattern engaged during the steps. The stamp can now be raised off the substrate up to the clamped area and another area of liquid resin can be applied to the substrate. If applied correctly, resin will wick into the clamped area up to the first embossed pattern. The stamp is then lowered into the resin and laminate to the substrate pressing out any excess resin. ultraviolet light once again cures the resin and the stamp is removed. This process can be repeated, thus seamlessly replicating the pattern. Once the desired area has been created on the substrate, a new larger stamp can be made by covering the entire embossed area with stamp resin and polymer film. Once the long seamless stamp has been created, the process can be repeated orthogonally to create a wider area. For example, the stamp can start as 5″×6″ original and create a 5″×17″ long stamp. Then working in the other direction, it can be multiplied out in width to 17″×27.5″. This is now a polymer master on a flat rigid substrate. Nickel can then be electroformed into this master to create a durable shim for production embossing.

The self-aligning process of embossing patterns on a cylindrical surface is similar to the flat surface process and as follows. In this case, the stamp and embossing patterns are aligned and engaged along two overlapped areas. The diameter of such a structure can only be discrete values stepping by the same amount the original pattern repeats. The gap in the embossing is then filled liquid resin and supported by another wrap of the film. As the same as in the flat surface process, the resin will fill up to the engaged stamp and embossing interface. The resin is then cured and the support mandrel, inner support film, and section of the stamp can be removed. An outer support structure can be added to maintain a cylindrical or any other shape. This leaves a seamless continuous pattern in the interior of the film cylinder. The inner surface of the polymer master can then be coated using an electroless platting process with a silver platting being one option. By running a nickel anode through the center of the cylinder, a nickel sleeve can be electroformed into the resin pattern. The resin and film can be removed leaving the nickel sleeve ready for production embossing.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is a diagram of the first step in the self-aligning embossing technique for flat surfaces.

FIG. 2 is a diagram of the second step in the self-aligning embossing technique for flat surfaces.

FIG. 3 is a diagram of the third step in the self-aligning embossing technique for flat surfaces.

FIG. 4 is a diagram of the fourth step in the self-aligning embossing technique for flat surfaces.

FIG. 5 is a diagram of the fifth step in the self-aligning embossing technique for flat surfaces.

FIG. 6 is a diagram of the sixth step in the self-aligning embossing technique for flat surfaces.

FIG. 7 is a diagram of the seventh step in the self-aligning embossing technique for flat surfaces.

FIG. 8 is a diagram of the first step in the self-aligning embossing technique for cylindric surfaces.

FIG. 9 is a diagram of the second step in the self-aligning embossing technique for cylindric surfaces.

FIG. 10 is a diagram of the third step in the self-aligning embossing technique for cylindric surfaces.

FIG. 11 is a diagram of the fourth step in the self-aligning embossing technique for cylindric surfaces.

FIG. 12 is an image of the micro design during the embossing step of manufacturing.

### DETAILED DESCRIPTION OF THE PREFERRED EMBODIMENT

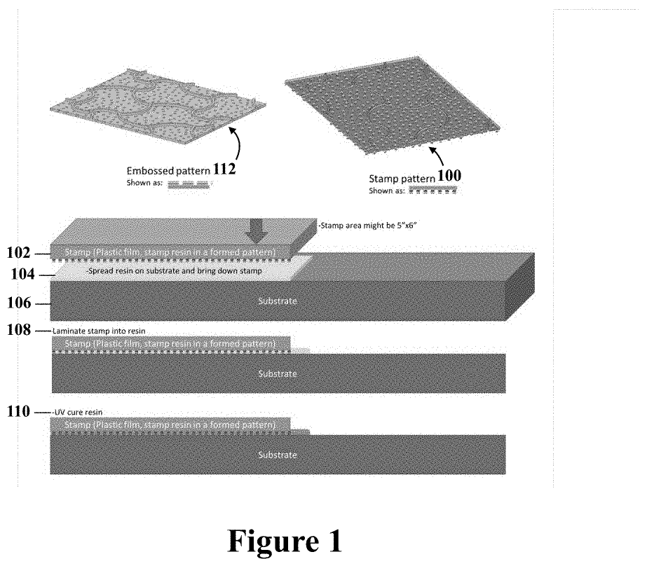

FIG. 1 is a diagram of the first step in the self-aligning embossing technique for flat surfaces. It begins with the imprinting or embossing using a stamp and liquid resin onto a flat surface. A stamp pattern 100, consisting of plastic film, stamps down on the resin in a formed pattern 102. The stamp is brought down on a layer of resin 104 spread on a substrate 106. The stamp is them laminated into the resin 108. The stamped resin is then cured using an ultraviolet curing method 108, which is a photochemical process in which high-intensity ultraviolet light is used to instantly cure or dry inks, coatings or adhesives. Ultraviolet formulations are liquid monomers and oligomers mixed with a small percent of photo-initiators, and then exposed to ultraviolet energy. The embossed pattern 112 is formed when the ultraviolet light cures the resin 110.

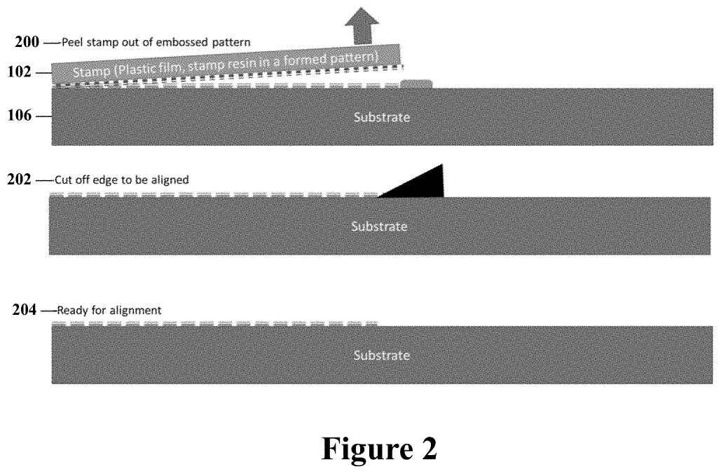

FIG. 2 is a diagram of the second step in the self-aligning embossing technique for flat surfaces. The stamp 102 is peeled upward off of the embossed pattern 112, reserving the stamp 102. One edge of the embossed pattern 112 is then cleaned by cutting off the edge of the embossed pattern 202 so that any excess resin or defects are removed. Only the pattern will remain and the substrate 106 will then be ready for alignment 204.

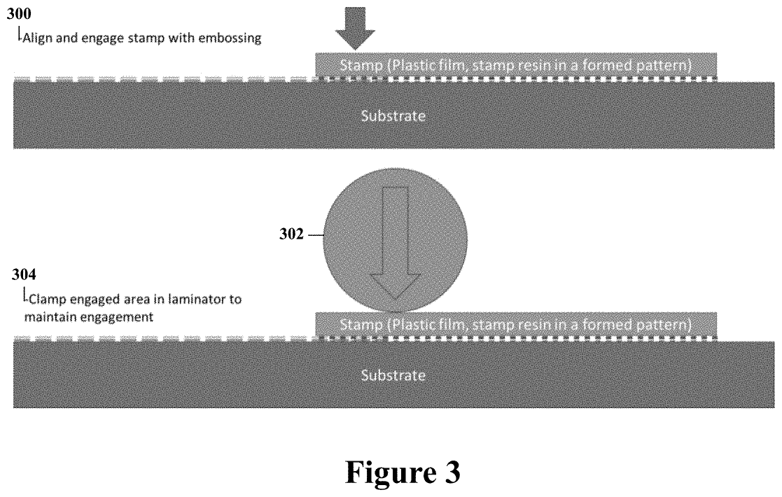

FIG. 3 is a diagram of the third step in the self-aligning embossing technique for flat surfaces. The stamp 102 is then shifted so that about ¼″ of the embossed pattern 112 is overlapped. The stamp 102 is aligned and engaged with the embossing 300. Once the stamp 102 is aligned, the stamp 102 can be pressed into the embossing in a small area 302. The engagement will cause self-alignment of the pattern on the nano-scale and then the engaged area can be expanded from the initial spot to eventually cover the entire overlapped area. Next, the engaged area of the pattern is clamped 304 in a lamination roller to keep the pattern engaged during the next steps.

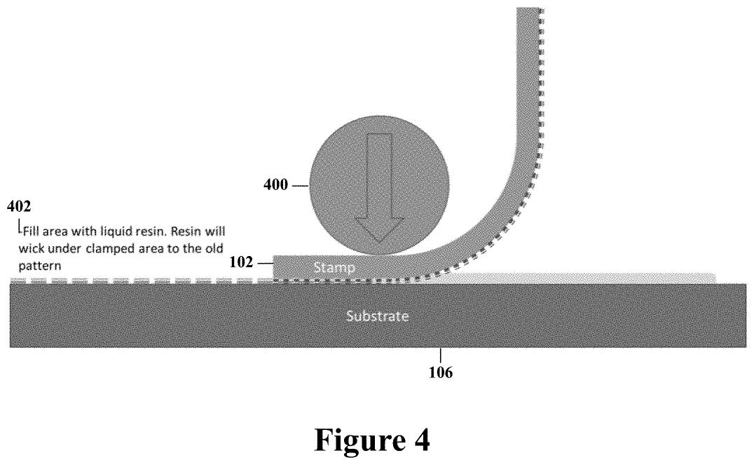

FIG. 4 is a diagram of the fourth step in the self-aligning embossing technique for flat surfaces. The stamp 102 is raised 400 off of the substrate 106 up to the clamped area and another area of liquid resin can be applied 402 to the substrate 106. If applied correctly, the resin will wick into the clamped area up to the first embossed pattern 402.

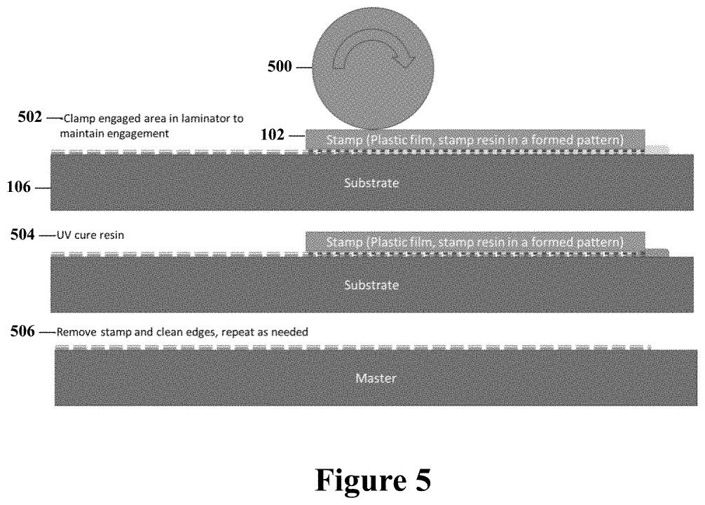

FIG. 5 is a diagram of the fifth step in the self-aligning embossing technique for flat surfaces. The stamp 102 is then lowered into the resin and laminate to the substrate 106 pressing out any excess resin 500. The engaged area is clamped in a laminator to maintain engagement 502. Ultraviolet light cures the resin 504 and the stamp is again removed. The process is then repeated 506, seamlessly replicating the pattern.

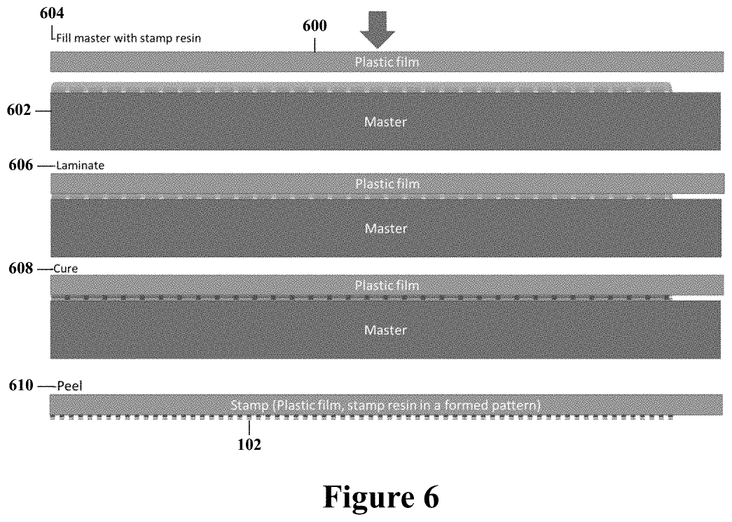

FIG. 6 is a diagram of the sixth step in the self-aligning embossing technique for flat surfaces. Once the desired area has been created on the substrate, a new larger stamp can be made by covering the entire embossed area with the stamp and polymer film 600. The master 602 is filled with stamp resin 604. The film 600 is laminated 606 to the master 602. The film 600 is then cured 608 to the master 602. The formed stamp 102 is then peeled 610 and ready for use.

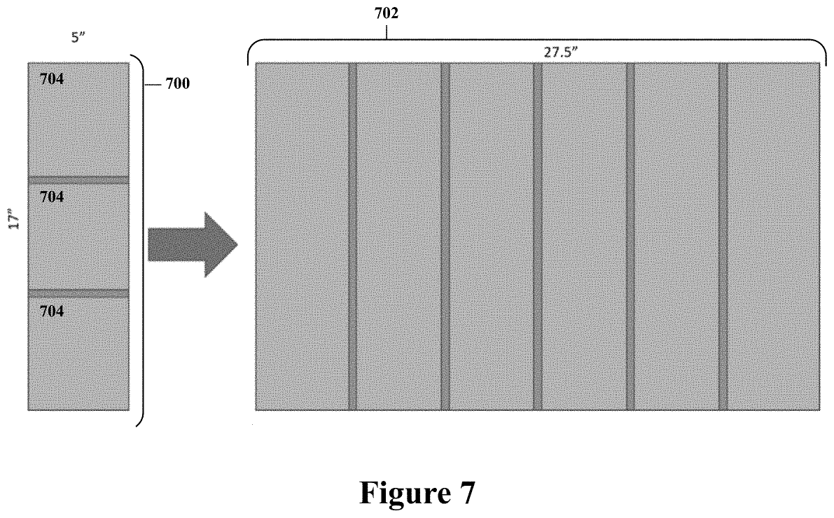

FIG. 7 is a diagram of the seventh step in the self-aligning embossing technique for flat surfaces. Once the long seamless stamp has been created 700, the process can be repeated orthogonally to create a wider area 702. In this example, it begins with 5″×6″ sections to create 5″×17″ long stamp 700. From there, the 5″×17″ long stamp 700 can be multiplied out in width to create a wider area, for example 17″×27.5″ 702. This is now a polymer master on a flat rigid substrate.

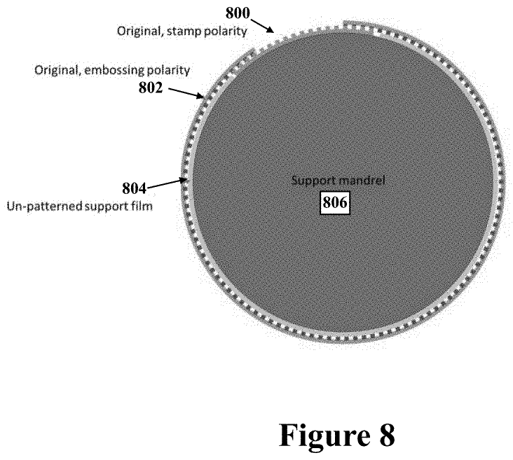

FIG. 8 is a diagram of the first step in the self-aligning embossing technique for cylindric surfaces. It is a similar process as the flat surface technique. The stamp polarity 800, and embossing polarity 802 are aligned and engaged along two overlapped areas, such as un-pattered support film 804, on a support mandrel 804. The diameter of such a structure can only be discrete values stepping by the same amount the original pattern repeats.

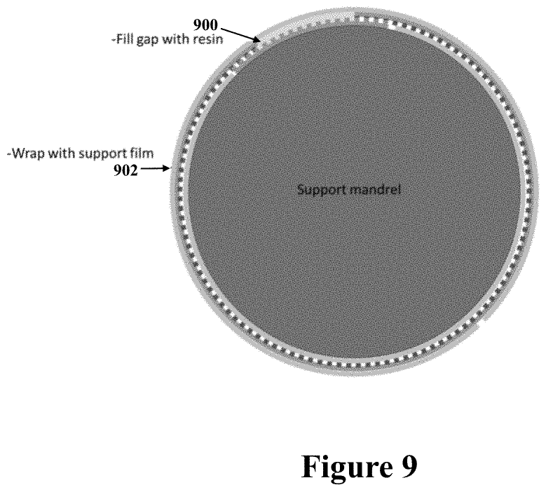

FIG. 9 is a diagram of the second step in the self-aligning embossing technique for cylindric surfaces. The gap in the embossing is filled with liquid resin 900 and wrapped with support film 902. As in the flat example, the resin will fill up to the engaged stamp and embossing interface.

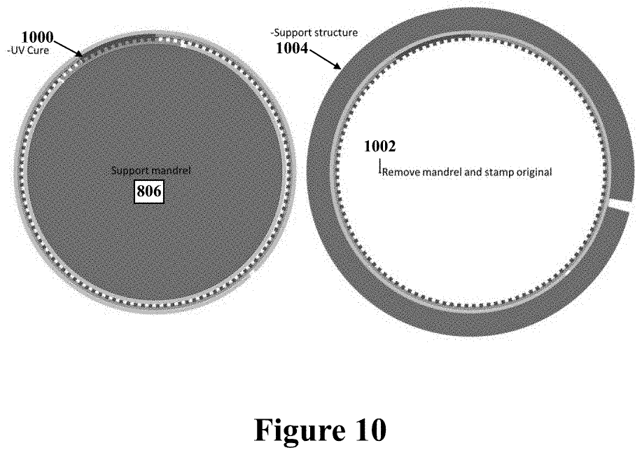

FIG. 10 is a diagram of the third step in the self-aligning embossing technique for cylindric surfaces. The resin is cured 1000 using ultraviolet light and the support mandrel 806, inner support film, and section of stamp can be removed 1002. An outer support structure 1004 can be added to maintain a cylindrical or other shape. This leaves a seamless continuous pattern in the interior of the film cylinder.

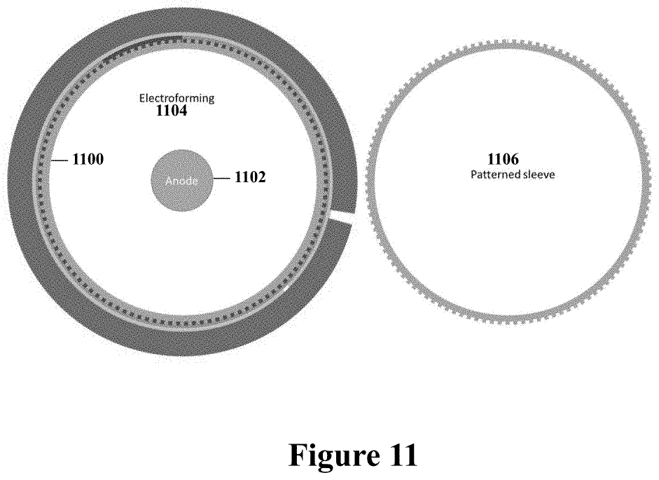

FIG. 11 is a diagram of the fourth step in the self-aligning embossing technique for cylindric surfaces. The inner surface of the polymer master can be coated using electroless platting process with a silver plating being one option. By running a nickel anode 1102 through the center of the cylinder, a nickel sleeve can be electroformed 1104 into the resin pattern. The resin and film can be removed leaving the nickel sleeve 1106 ready for production embossing.

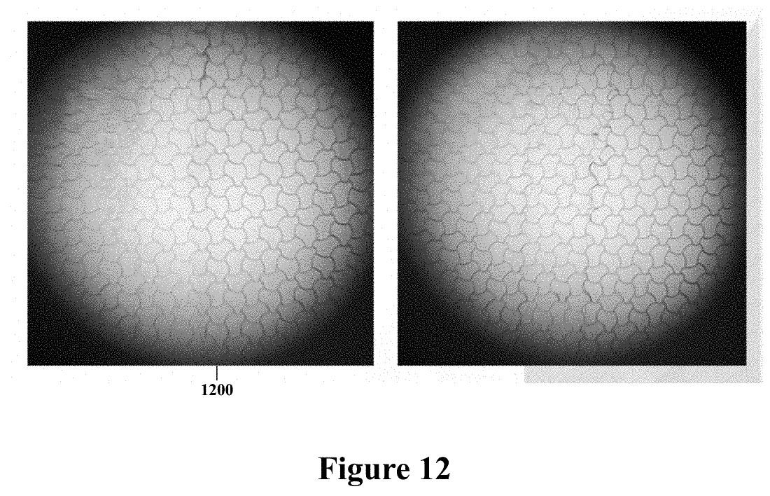

FIG. 12 is an image of the micro design 1200 during the embossing step of manufacturing. The stitching and mastering manufacturing processes and techniques of the present invention solve an industry challenge. The stitching allows for the verticalization of all important manufacturing steps, eliminating the need to rely on third party for mastering.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A process for embossing a film, the process comprising:
heating resin formulations to create a stamp for continuing an embossing pattern wherein said embossing pattern is repeated;
peeling said stamp from said embossing pattern over an integer of number patterns and placing said stamp back into said embossing pattern at a different location for enabling a seamlessly replicating pattern upon a pattern area.

2. A process according to claim 1 wherein said area is a cylinder.

3. A process according to claim 1 wherein said area is a flat surface.

4. The process according to claim 1 wherein said embossing process is self-aligning and begins with embossing a pattern by way of a stamp and liquid resin on a flat substrate, using said resin to spread over said substrate, and then stamping the plastic film into resin to create said formed pattern.

5. A process according to claim 4 wherein ultraviolet light waves cure said resin and stamp and is peeled out of said embossing reserving said stamp.

6. A process according to claim 5 wherein an edge of said embossing is then cleaned off so that any edge defects or excess resin is removed and only the pattern remains.

7. A process according to claim 1 wherein a cylindrical surface forms said embossing surface.

8. An embossed film formed by:
heating resin formulations to create a stamp for continuing an embossing pattern wherein said embossing pattern is repeated;
peeling said stamp from said embossing pattern over an integer number of patterns and placing said stamp back into said embossing pattern at a different location for enabling a seamlessly replicating pattern upon a pattern area.

9. An embossed film according to claim 8 wherein said area is a cylinder.

10. An embossed film according to claim 8 wherein said area is a flat surface.

11. An embossed film according to claim 8 wherein said embossing process is self-aligning and begins with embossing a pattern by way of a stamp and liquid resin on a flat substrate, using said resin to spread over said substrate, and then stamping the plastic film into resin to create said formed pattern.

12. An embossed film according to claim 11 wherein UV waves cure said resin and stamp and is peeled out of said embossing reserving said stamp.

13. An embossed film according to claim 12 wherein an edge of said embossing is then cleaned off so that any edge defects or excess resin is removed and only the pattern remains.

14. An embossed film according to claim 8 wherein a cylindrical surface forms said embossing surface.

15. An embossed film formed by:
heating resin formulations to create a stamp for continuing an embossing pattern wherein said embossing pattern is repeated;
peeling said stamp from said embossing pattern over an integer of number patterns and placing said stamp back into said embossing pattern at a different location for enabling a seamlessly replicating pattern upon a pattern area, and wherein said area is a flat surface; and
wherein said embossing process is self-aligning and starts with embossing of a formed pattern using a stamp and liquid resin on a flat substrate, and then said resin is spread on said substrate and then a plastic film is then stamped into said resin to create said formed pattern.

16. An embossed film according to claim 15 wherein:
said stamp is well aligned and will be pressed into an embossing of a small area and a corresponding engagement will cause self-alignment of said pattern on a nanoscale and said engaged area expands from an initial spot and graduates to entire overlapped area.

17. An embossed film according to claim 16 wherein a clamp engages an area of said pattern in a lamination roller to keep said pattern engaged during formation steps and said stamp is raised off said substrate up to said clamp and proximity and enables another area of liquid resin applicated to said substrate.

18. An embossed film according to claim 17 wherein said resin will wick into said clamp and an area proximal to said clamp up to said first embossed pattern and wherein said stamp forms a seamless replicating pattern.
